(19) United States
(12) Patent Application Publication
(10) Pub. No.: US 2026/0036707 A1
(43) Pub. Date: Feb. 5, 2026

(54) vibration hammer and seismic-wave-excitation device

(71) Applicant: Shanghai Investigation, Design & Research Institute Co., Ltd., Shanghai (CN)

(72) Inventors: Ye TIAN, Shanghai (CN); Hengxiang LIU, Shanghai (CN); Bo CHEN, Shanghai (CN); Hao WANG, Shanghai (CN); Yongxu MENG, Shanghai (CN); Kaikai XU, Shanghai (CN); Xiaoqing DING, Shanghai (CN); Shenghua FAN, Shanghai (CN); Hailiang JI, Shanghai (CN); Genfa GUO, Shanghai (CN); Yafeng SONG, Shanghai (CN); Miaoyuan GU, Shanghai (CN); Jinghui YANG, Shanghai (CN); Xin RONG, Shanghai (CN); Laixiang XU, Shanghai (CN); Pengguan WU, Shanghai (CN)

(73) Assignee: Shanghai Investigation, Design & Research Institute Co., Ltd., Shanghai (CN)

(21) Appl. No.: 18/842,815

(22) PCT Filed: Mar. 28, 2024
(86) PCT No.: PCT/CN2024/084606

§ 371 Date: Jul. 28, 2025

(30) Foreign Application Priority Data
Apr. 28, 2023 (CN) 2023104805691

(51) Int. Cl. G01V 1/04; G01V 1/147

(52) U.S. Cl. CPC G01V 1/04; G01V 1/147

(57) ABSTRACT

A vibration hammer and a seismic wave excitation device are provided. The vibration hammer comprises a housing, a striking head, a heavy hammer body, an elastic trigger structure, a ball clamping mechanism, and a telescopic power cylinder. An accommodating inner cavity within the housing is sealed. The striking head moves linearly relative to the housing in a striking direction. The telescopic power cylinder is fixed in the housing and its piston rod extends into the accommodating inner cavity in the striking direction. The elastic trigger structure and the heavy hammer body are mounted in the accommodating inner cavity, the heavy hammer body moves in the striking direction, and when the heavy hammer body moves away from the striking head, the heavy hammer body places the elastic trigger structure in an elastic energy storage state, at which time the elastic trigger structure applies an elastic force to the heavy hammer body.

### FIELD OF THE INVENTION

The present disclosure relates to the field of geotechnical engineering and geological technology, and in particular, to a vibration hammer and a seismic wave excitation device.

### BACKGROUND OF THE INVENTION

The single-hole method for wave velocity testing is an essential technique in geotechnical engineering for measuring the shear wave velocity, compression wave velocity, dynamic shear modulus, dynamic elastic modulus, and dynamic Poisson's ratio of soil and rock masses. During wave velocity testing, seismic waves need to be generated. Currently, the single-hole method often uses transient surface excitation: a large hammer strikes a weighted shear plate horizontally at the hole opening to generate seismic waves with a high shear wave component, and strikes a round iron plate vertically to generate seismic waves with a high compression wave component. However, this method is physically demanding, inefficient, and it is difficult to maintain consistent hammering force each time, leading to inconsistent waveforms.

To replace manual hammering, existing designs use gravity to let a heavy hammer fall for striking, but this approach cannot achieve horizontal strikes. Some existing excitation devices use springs to drive the heavy hammer for striking. For example, Utility Model Patent Application No. CN201822133456.1U discloses a shear wave measuring excitation device that uses spring force to drive the hammer to strike a wooden board, generating shear waves. This type of excitation device can achieve horizontal strikes to generate seismic waves, eliminating the need for manual hammering but still requiring some manual operation. Further, these devices are not suitable for generating seismic waves on a seabed surface. Underwater, it is difficult to operate manually and requires control from the shore. Additionally, due to the presence of seawater, ordinary vibration hammers are affected by water resistance, making it challenging to achieve effective striking.

### SUMMARY OF THE INVENTION

In view of the above-mentioned shortcomings, the present disclosure provides a vibration hammer and a seismic wave excitation device, which are suitable for automated underwater operations, eliminating the need for manual intervention underwater.

A first embodiment of the present disclosure provides a vibration hammer. The vibration hammer comprises a housing, a striking head, a heavy hammer body, an elastic trigger structure, a ball clamping mechanism, and a telescopic power cylinder. An accommodating inner cavity within the housing is sealed, the striking head is mounted at a first end of the housing, with part of the striking head located inside the accommodating inner cavity and part of the striking head located outside the housing, and the striking head is configured to move linearly relative to the housing in a striking direction. The telescopic power cylinder is fixed to a second end of the housing opposite to the first end, and a piston rod of the telescopic power cylinder extends into the accommodating inner cavity in the striking direction. The elastic trigger structure and the heavy hammer body are mounted in the accommodating inner cavity, the heavy hammer body is configured to move in the striking direction, and when the heavy hammer body moves away from the striking head, the heavy hammer body places the elastic trigger structure in an elastic energy storage state, at which time the elastic trigger structure applies an elastic force towards the striking head to the heavy hammer body. The ball clamping mechanism comprises a positioning rod, a clamping seat, a ball seat, a ball sleeve, one or more first clamping balls, one or more second clamping balls, and a reset spring. The positioning rod is mounted in the accommodating inner cavity and an axis of the positioning rod is parallel to the striking direction. The positioning rod comprises a thick rod section near the first end of the housing and a thin rod section near the second end of the housing, with a smooth transition surface between the thick rod section and the thin rod section. The ball seat is sleeved on the positioning rod and is fixedly connected to the piston rod, and the ball seat is configured to move on the thick rod section. The ball seat is provided with one or more first radial through holes, each of the first clamping balls is located in one of the first radial through holes, the ball seat is further provided with a limiting stopper, the ball sleeve is mounted on the ball seat, and the ball sleeve is configured to move relative to the ball seat along the striking direction and be locked circumferentially. The ball sleeve is provided with one or more second radial through holes, each of the second clamping balls is located in one of the second radial through holes, the reset spring applies an elastic force towards the first end of the housing to the ball sleeve to make the ball sleeve abut the limiting stopper, and each of the second radial through holes is aligned with a corresponding one of the first radial through holes. The clamping seat is fixedly connected to the heavy hammer body and has a clamping portion, the clamping portion has a clamping inner end facing the positioning rod, and the ball seat and the ball sleeve pass between the clamping inner end and the positioning rod when moving. The clamping inner end has a first guide slope facing the first end of the housing and a second guide slope facing the second end of the housing, distances from the clamping inner end to the thick rod section and the thin rod section along a radial direction of the positioning rod are denoted as H1 and H2, respectively, and diameters of each of the first clamping balls and each of the second clamping balls are denoted as D1 and D2, respectively, with H1<D1+D2≤H2.

Further, the striking head comprises an outer striking plate located outside the housing, an inner receiving head located inside the accommodating inner cavity, and an intermediate rod connecting the outer striking plate and the inner receiving head, and the intermediate rod extends through the housing and is in sealing contact with the housing.

Further, an end of the positioning rod facing the first end of the housing is mounted in the striking head.

Further, the accommodating inner cavity is cylindrical, an axis of the accommodating inner cavity is in the striking direction, the heavy hammer body is cylindrical and coaxially arranged in the accommodating inner cavity, the heavy hammer body is in clearance fit with the accommodating inner cavity, and two parts of the accommodating inner cavity located at two axial ends of the heavy hammer body are in communication.

Further, the heavy hammer body is provided with vent holes, and the vent holes penetrate the heavy hammer body in a direction parallel to the axis of the accommodating inner cavity.

Further, the elastic trigger structure comprises a compression spring, the compression spring is located at a side of the heavy hammer body near the second end of the housing, a first end of the compression spring is connected to the housing, and a second end of the compression spring contacts the heavy hammer body.

Further, the ball clamping mechanism further comprises guide rods fixed to the piston rod, the guide rods are arranged in the striking direction, the ball sleeve is provided with guide through holes, and each of the guide through holes is matingly connected to one of the guide rods.

A second embodiment of the present disclosure provides a seismic wave excitation device. The seismic wave excitation device of the present disclosure is configured to generate seismic waves on a seabed. The seismic wave excitation device comprises a bracket, a chopping board, trigger rods, and vibration hammers, each of which is a vibration hammer as described in any one of the examples provided in the first embodiment of the present disclosure. The chopping board is connected with the bracket and is configured to move in a horizontal direction and a vertical direction relative to the seabed, the chopping board is mounted on a surface of the seabed, the trigger rods are mounted on the chopping board and are configured to be inserted into the seabed, and the vibration hammers are mounted on the bracket. One of the vibration hammers is located over the chopping board and is configured to apply a vertical striking to the chopping board, and the other vibration hammers are located at sides of the chopping board and each is configured to apply a horizontal striking to the chopping board, respectively.

Further, the bracket comprises a guide column, sliding rib plates, connecting plates, and connecting guide rods. The guide column extends in the horizontal direction, each of the sliding rib plates is mounted on the guide column and movable along the guide column, and each of the connecting plates is fixed to one of the sliding rib plates. The chopping board is located below the connecting plates, each of the connecting plates is provided with guide holes to match with the connecting guide rods, each of the connecting guide rods extends through one of the guide holes, and a lower end of each of the connecting guide rods is fixedly connected to the chopping board.

Further, each of the trigger rods comprises a cylindrical pipe and vertical strips welded on two sides of the cylindrical pipe.

As described above, the vibration hammer and the seismic wave excitation device of the present disclosure have the following beneficial effects.

1. The vibration hammer and the seismic wave excitation device of the present disclosure are suitable for automated underwater operations, eliminating the need for manual intervention underwater. They can operate fully automatically with control systems above water, making them particularly suitable for deep-sea operations.

2. The vibration hammer generates a consistent amount of kinetic energy with each use, ensuring stable and reliable performance. The seismic wave excitation device produces waveforms with excellent repeatability and has the capability of waveform superposition; it can generate two sets of shear waveforms with opposite phases, which, when received by detectors, can be better filtered through a wave velocity tester, thereby enhancing the accuracy of the test results.

### BRIEF DESCRIPTION OF DRAWINGS

FIG. 1 is a schematic structural diagram of a vibration hammer in a first state according to the present disclosure.

FIG. 2 is a schematic structural diagram of a ball clamping mechanism according to the present disclosure.

FIG. 3 is an enlarged view of Circle A in FIG. 2.

FIG. 4 is a schematic structural diagram of the vibration hammer in a second state according to the present disclosure.

FIG. 5 is a schematic structural diagram of the vibration hammer in a third state according to the present disclosure.

FIG. 6 is a schematic structural diagram of the vibration hammer in a fourth state according to the present disclosure.

FIG. 7 is a schematic structural diagram of the vibration hammer in a fifth state according to the present disclosure.

FIG. 8 is a cross-sectional view of the vibration hammer along Line B-B in FIG. 7.

FIG. 9 is a cross-sectional view of the vibration hammer along Line C-C in FIG. 7.

FIG. 10 is a schematic structural diagram of the vibration hammer in a sixth state according to the present disclosure.

FIG. 11 is a schematic structural diagram of a seismic wave excitation device according to the present disclosure.

FIG. 12 is a front view of the seismic wave excitation device in FIG. 11.

FIG. 13 is a top view of the seismic wave excitation device in FIG. 11.

FIG. 14 is a left view of the seismic wave excitation device in FIG. 11.

FIG. 15 is a schematic diagram showing a working state of the seismic wave excitation device according to the present disclosure.

### REFERENCE NUMERALS

1 Striking head
11 Outer striking plate
12 Inner receiving head
13 Intermediate rod
2 Housing
21 Accommodating inner cavity
3 Heavy hammer body
31 Vent hole
4 Telescopic power cylinder
41 Piston rod
411 Accommodating inner hole
5 Ball clamping mechanism
51 Positioning rod
511 Thick rod section
512 Thin rod section
52 Clamping seat
521 Clamping portion
522 First guide slope
523 Second guide slope
524 Clamping inner end
53 Ball seat
531 First radial through hole
532 Limiting stopper
54 Ball sleeve
541 Second radial through hole
55 First clamping ball
56 Second clamping ball
57 Reset spring
58 Guide rod
6 Elastic trigger structure
7 Bracket
71 Guide column
72 Sliding rib plate
73 Connecting plate
74 Connecting guide rod
75 Fixed rib plate
76 Flange plate
8 Chopping board
9 Trigger rod
91 Cylindrical pipe
92 Vertical strip
10 Weight base

### DETAILED DESCRIPTION OF THE INVENTION

The embodiments of the present disclosure will be described below. Those skilled can easily understand disclosure advantages and effects of the present disclosure according to contents disclosed by the specification.

It should be understood that the structures, proportions, sizes, and the like, which are illustrated in the drawings of the present specification, are only used to clarify the contents disclosed in the specification for understanding and reading by those skilled, and are not intended to restrict the implementation of the present disclosure, thus are not technically meaningful. Any modification of the structure, change of the scale, or adjustment of the size should still fall within the scope of the technical contents disclosed by the present disclosure without affecting the effects and achievable objectives of the present disclosure. Terms such as “upper”, “lower”, “left”, “right”, and “middle” used in this specification are only for ease of description, and they are not intended to restrict the scope of implementation of the present invention. Any change or adjustment of corresponding relative relationships without any substantial technical change should be regarded as within the scope of the implementation of the present disclosure.

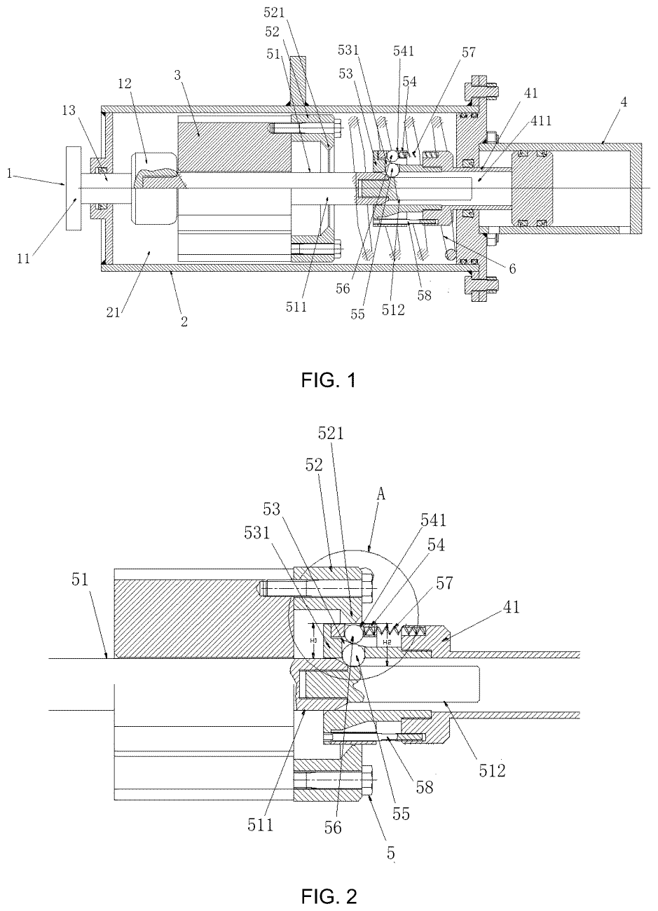

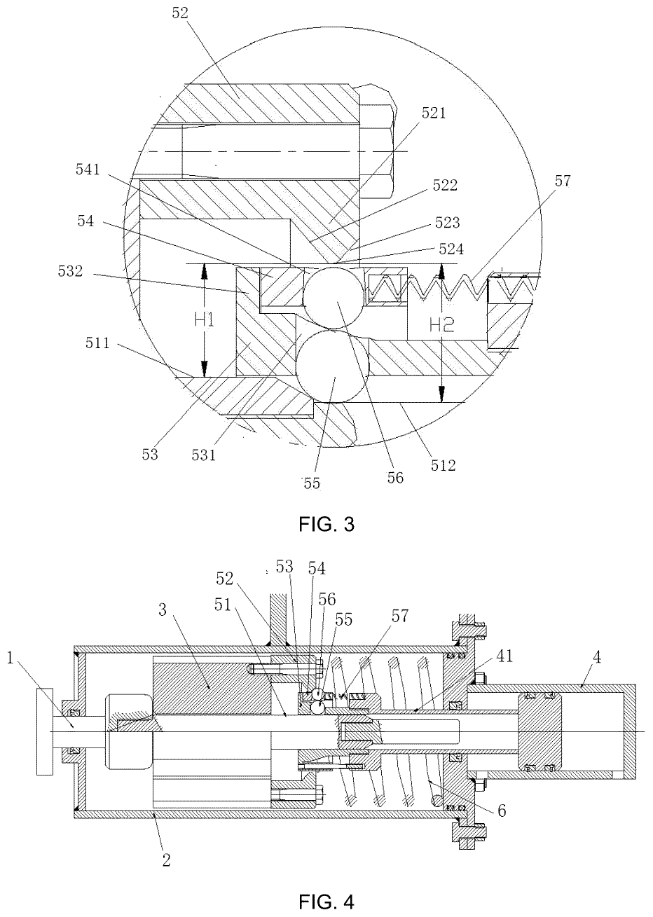

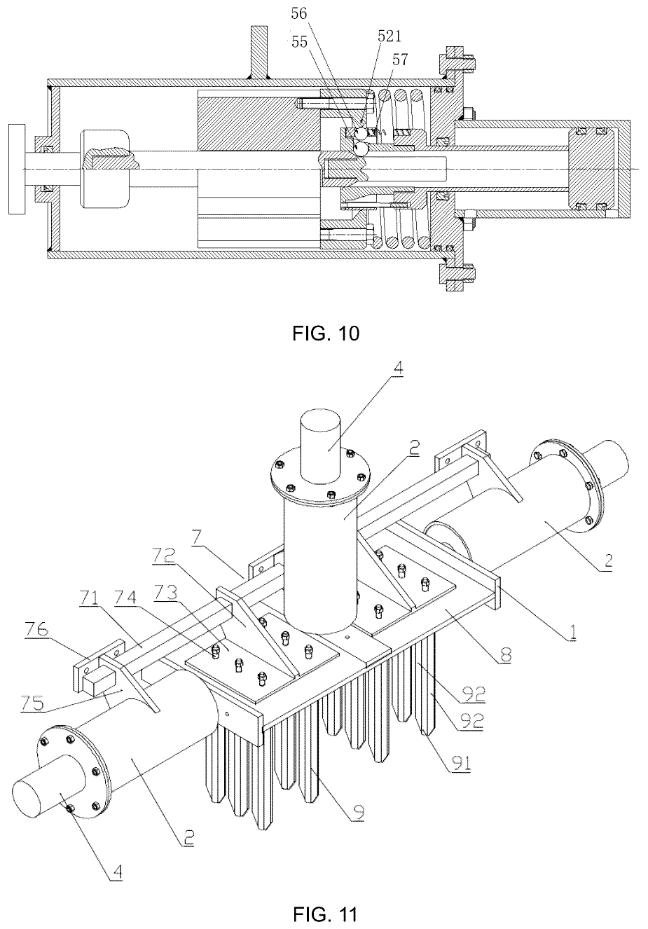

Referring to FIGS. 1-10, the present disclosure provides a vibration hammer, comprising a housing 2, a striking head 1, a heavy hammer body 3, an elastic trigger structure 6, a ball clamping mechanism 5, and a telescopic power cylinder 4. An accommodating inner cavity 21 within the housing 2 is sealed to prevent seawater from entering. Preferably, the housing 2 and the accommodating inner cavity 21 within the housing 2 are cylindrical, and two axial ends of the housing 2 are denoted as a first end and a second end of the housing 2, respectively.

Referring to FIG. 1, the striking head 1 is mounted on a first end panel located at the first end of the housing 2, with part of the striking head 1 located inside the accommodating inner cavity 21 and part of the striking head 1 located outside the housing 2, and the striking head 1 is configured to move linearly relative to the housing 2 in a striking direction. Preferably, the striking head 1 comprises an outer striking plate 11 located outside the housing 2, an inner receiving head 12 located inside the accommodating inner cavity 21, and an intermediate rod 13 connecting the outer striking plate 11 and the inner receiving head 12. The outer striking plate 11 is configured to increase the contact area with the object being struck, ensuring a stable striking effect. The inner receiving head 12 absorbs the striking force from the heavy hammer body 3. The intermediate rod 13 extends through the housing 2 and is in sealing contact with the first end panel of the housing 2 through a sealing ring, which allows the intermediate rod 13 to move while maintaining the sealing integrity of the accommodating inner cavity 21. An axis of the intermediate rod 13 is parallel to the striking direction, and in one embodiment of the present disclosure, the axis of the intermediate rod 13 coincides with that of the housing 2.

Referring to FIG. 1, the telescopic power cylinder 4 is fixed to a second end panel located at the second end of the housing 2, and a piston rod 41 of the telescopic power cylinder 4 extends into the accommodating inner cavity 21 in the striking direction. The piston rod 41 is coaxially arranged in the housing 2 (that is, the two are coaxial). The telescopic power cylinder 4 may be a hydraulic cylinder or a pneumatic cylinder.

Referring to FIG. 1, the elastic trigger structure 6 and the heavy hammer body 3 are mounted in the accommodating inner cavity 21, the heavy hammer body 3 is configured to move in the striking direction, and when the heavy hammer body 3 moves away from the striking head 1, the heavy hammer body 3 places the elastic trigger structure 6 in an elastic energy storage state (that is, compressed), at which time the elastic trigger structure 6 applies an elastic force towards the striking head 1 to the heavy hammer body 3. Preferably, in one embodiment of the present disclosure, the elastic trigger structure 6 comprises a compression spring, the compression spring is located in the accommodating inner cavity 21 and is positioned near the second end of the housing 2, and the heavy hammer body 3 compresses the compression spring when moving towards the second end of the housing 2. The heavy hammer body 3 is cylindrical and coaxially arranged in the accommodating inner cavity 21. The heavy hammer body 3 is in clearance fit with the accommodating inner cavity 21, and is movable along the striking direction. Two parts of the accommodating inner cavity 21 located at two axial ends of the heavy hammer body 3 are in communication. Specifically, referring to FIG. 14, the heavy hammer body 3 is provided with vent holes 31, and the vent holes 31 penetrate the heavy hammer body 3 in a direction parallel to the axis of the housing 2, which allows air to circulate freely between the two parts of the accommodating inner cavity 21 as the heavy hammer body 3 moves, ensuring unobstructed movement of the heavy hammer body 3 and reducing kinetic energy loss.

Referring to FIGS. 6, 7 and 8, the ball clamping mechanism 5 facilitates the connection and disconnection of the piston rod 41 and the heavy hammer body 3, and comprises a positioning rod 51, a clamping seat 52, a ball seat 53, a ball sleeve 54, one or more first clamping balls 55, one or more second clamping balls 56, and a reset spring 57. The positioning rod 51 is mounted in the accommodating inner cavity 21 and an axis of the positioning rod 51 is parallel to the striking direction. In one embodiment of the present disclosure, the axis of the positioning rod 51 coincides with those of the heavy hammer body 3 and the piston rod 41. The positioning rod 51 comprises a thick rod section 511 near the first end of the housing 2 and a thin rod section 512 near the second end of the housing 2, with a smooth transition surface between the thick rod section 511 and the thin rod section 512. Preferably, the piston rod 41 has an accommodating inner hole 411 to allow the insertion of the thin rod section 512, preventing any collision or interference. An end of the positioning rod 51 facing the first end of the housing 2 is connected to the striking head 1 for added stability. The ball seat 53 is sleeved on the positioning rod 51 and is fixedly connected to the piston rod 41, and the ball seat 53 is configured to move on the thick rod section 511. The ball seat 53 is provided with one or more first radial through holes 531, each of the first clamping balls 55 is located in one of the first radial through holes 531, the ball seat 53 is further provided with a limiting stopper 532, the ball sleeve 54 is mounted on the ball seat 53, and the ball sleeve 54 is configured to move relative to the ball seat 53 along the striking direction and be locked circumferentially. In other words, the ball sleeve 54 can move linearly but cannot rotate circumferentially. The ball sleeve 54 is provided with one or more second radial through holes 541, each of the second clamping balls 56 is located in one of the second radial through holes 541, the reset spring 57 applies an elastic force towards the first end of the housing 2 to the ball sleeve 54 to make the ball sleeve 54 abut the limiting stopper 532, and each of the second radial through holes 541 is aligned with a corresponding one of the first radial through holes 531. In other words, an axis of one of the second radial through holes 541 coincides with that of the corresponding first radial through hole 531. Specifically, the reset spring 57 is a compression spring located on one side of the ball sleeve 54 facing the second end of the housing 2. Two axial ends of the reset spring 57 extend into the ball sleeve 54 and the piston rod 41, respectively. The reset spring 57 ensures that the ball sleeve 54 abuts the limiting stopper 532, thereby aligning each second radial through hole 541 with the corresponding first radial through hole 531 in the absence of external force. The clamping seat 52 is fixedly connected to the heavy hammer body 3 and has a clamping portion 521, and the clamping portion 521 has a clamping inner end 524 facing the positioning rod 51. There is a proper gap between the clamping inner end 524 and a surface of the positioning rod 51, allowing the ball seat 53 and the ball sleeve 54 to move through the gap. The clamping inner end 524 has a first guide slope 522 facing the first end of the housing 2 and a second guide slope 523 facing the second end of the housing 2, distances from the clamping inner end 524 to the thick rod section 511 and the thin rod section 512 along a radial direction of the positioning rod 51 are denoted as H1 and H2, respectively, and diameters of each of the first clamping balls 55 and each of the second clamping balls 56 are denoted as D1 and D2, respectively, with H1<D1+D2≤H2. In one embodiment of the present disclosure, a radius of outer opening of each first radial through hole 531, facing the inner wall of the housing 2, is smaller than that of the first clamping balls 55, allowing the first clamping balls 55 to partially protrude through the first radial through hole 531 without completely detaching. Preferably, all of the first clamping balls 55 and second clamping balls 56 are made of steel.

In the vibration hammer of the present disclosure, when the telescopic power cylinder 4 is powered by a power unit, the power unit can be positioned either above water or underwater. In one embodiment of the present disclosure, the telescopic power cylinder 4 is a hydraulic cylinder, and the power unit is connected with the hydraulic cylinder through pipelines to supply hydraulic oil, facilitating underwater operation. The power unit comprises components like a pump station, hydraulic solenoid valve, and pipelines. When the telescopic power cylinder 4 is a pneumatic cylinder, the power unit supplies compressed gas to the cylinder. Both hydraulic and pneumatic cylinders are well-suited for underwater use.

In the vibration hammer of the present disclosure, the telescopic power cylinder 4 works in conjunction with the power unit, and the power unit is controlled by a control system. In one embodiment of the present disclosure, the power unit is mounted on a weight base 10.

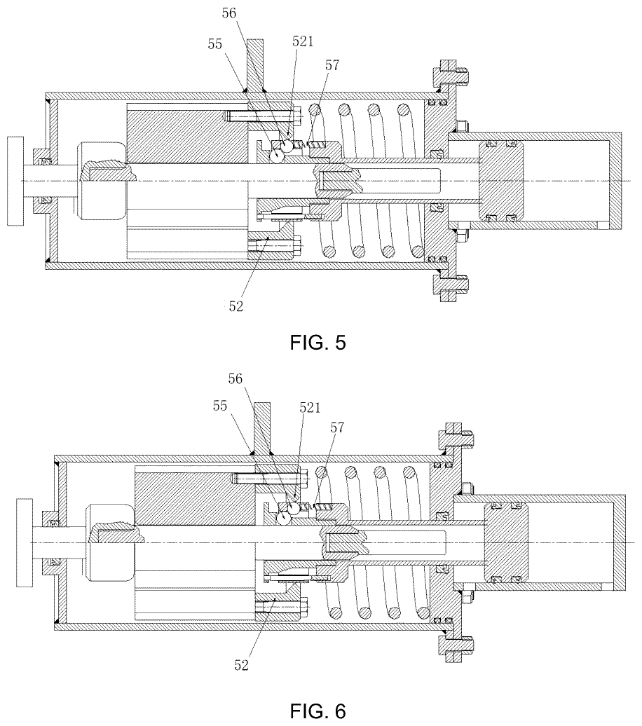

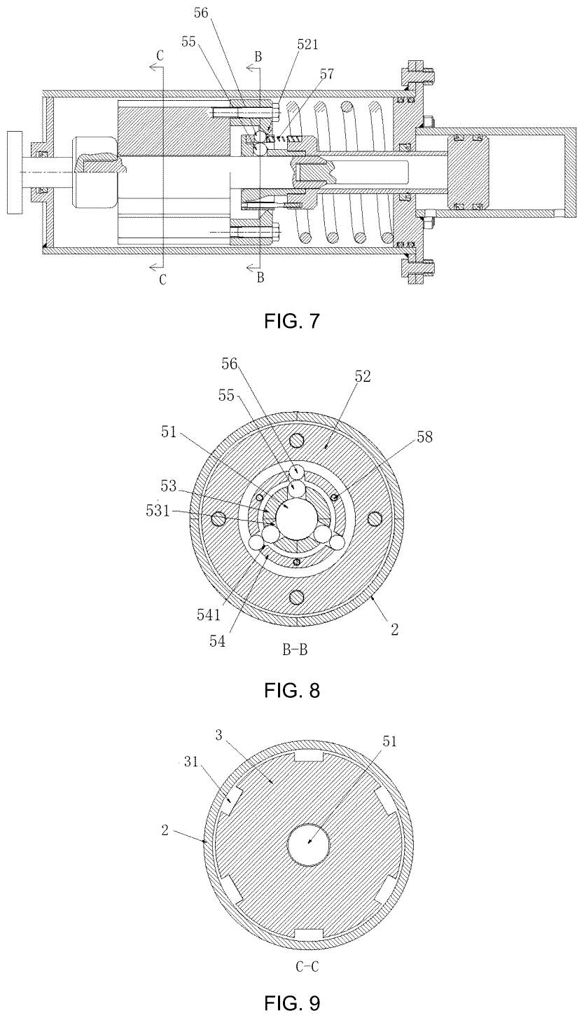

The working principle of the vibration hammer is as follows: In the initial state, when no striking action is performed (see FIG. 1), the telescopic power cylinder 4 is in a retracted state, with the ball seat 53 and the piston rod 41 near the second end of the housing 2. Under the action of the reset spring 57, the first radial through holes 531 and the second radial through holes 541, as well as the first clamping balls 55 and the second clamping balls 56, are aligned, at which time, the first clamping balls 55 are located at the thin rod section 512 of the positioning rod 51. When a striking action is required, the piston rod 41 of the telescopic power cylinder 4 extends, driving the ball seat 53 and the ball sleeve 54 towards the first end of the housing 2; the ball seat 53 reaches the thick rod section 511, and the first clamping balls 55 are positioned on a surface of the thick rod section 511; since the combined diameter (D1+D2) of each first clamping ball 55 and its corresponding second clamping ball 56 is greater than the distance H1 from the clamping inner end 524 to the surface of the thick rod section 511, i.e., D1+D2>H1, the second clamping balls 56 protrude from an outer peripheral surface of the ball sleeve 54 and come into contact with the second guide slope 523, as shown in FIG. 4. Next, as the piston rod 41 further extends, the clamping seat 52 and the heavy hammer body 3 no longer move towards the first end of the housing 2; the second guide slope 523 exerts pressure on the second clamping balls 56, an axial force towards the second end of the housing 2 drives the ball sleeve 54 to move towards the second end of the housing 2 against a force of the reset spring 57, as shown in FIG. 5. At this time, each second clamping ball 56 and its corresponding first clamping ball 55 misalign, with the second clamping ball 56 retracting into the corresponding second radial through hole 541, allowing the ball seat 53 and the ball sleeve 54 to cross the clamping inner end 524 and enter the side of the first guide slope 522, as shown in FIG. 6. Then, under the action of the reset spring 57, the ball sleeve 54 returns to abut the limiting stopper 532, and the second clamping balls 56 return to a position collinear with the first clamping balls 55, protruding from the second radial through holes 541 and contacting the first guide slope 522, as shown in FIG. 7; at which time, the piston rod 41 and the heavy hammer body 3 are connected through the ball clamping mechanism 5. Then, the piston rod 41 retracts, driving the ball seat 53 and the ball sleeve 54 towards the second end of the housing 2; the second clamping balls 56 act on the first guide slope 522 and is constrained by the first clamping balls 55 from retracting inward, thus applying thrust to the first guide slope 522, driving the clamping seat 52 and the heavy hammer body 3 to move linearly towards the second end of the housing 2; the elastic trigger structure 6 (compression spring) is compressed and stores energy until the first clamping balls 55 are positioned at a surface of the thin rod section 512; since the combined diameter (D1+D2) of each first clamping ball 55 and its corresponding second clamping ball 56 is less than or equal to the distance H2 from the clamping inner end 524 to the surface of the thin rod section 512, i.e., D1+D2≤H2, the second clamping balls 56 move towards the positioning rod 51 along the first guide slope 522, and the second clamping balls 56 and the first clamping balls 55 retract inward until the first clamping balls 55 contact the surface of the thin rod section 512, at which time the second clamping balls 56 disengage from the first guide slope 522, as shown in FIG. 10. The clamping seat 52 is no longer subjected to the pressure of the first clamping balls 55, at which time, the elastic trigger structure 6 has stored enough energy, which propels the clamping seat 52 and the heavy hammer body 3 quickly towards the first end of the housing 2; the heavy hammer body 3 then strikes the striking head 1, causing the striking head 1 to move outward and perform the striking action; after completing the striking action, the striking head 1 returns to the initial state, as shown in FIG. 1. The vibration hammer of the present disclosure can work well in seawater, unaffected by the seawater, with sufficient and stable striking force each time. The striking action can be automatically controlled without requiring manual operation underwater.

The vibration hammer of the present disclosure can automatically perform repeated striking actions by controlling the telescopic movement of the telescopic power cylinder 4. The operation of the telescopic power cylinder 4 can be managed by operating the corresponding power unit above water. By driving the telescopic power cylinder 4 to extend and retract at a specific frequency, there is no need for manual operation underwater, which makes it easy to operate the hammer. The telescopic power cylinder 4 provides a stable and reliable striking force and is user-friendly.

Referring to FIGS. 1, 7 and 8, in one embodiment of the present disclosure, as a preferred design, the ball seat 53 and the ball sleeve 54 are connected by multiple guide rods 58 fixed to the piston rod 41, the guide rods 58 are arranged in a direction parallel to the piston rod 41, the ball sleeve 54 is provided with guide through holes, and each of the guide through holes is matingly connected to one of the guide rods 58, which allows the ball sleeve 54 to move linearly along the guide rods 58 relative to the ball seat 53, while preventing the ball sleeve 54 from rotating circumferentially, ensuring that each first radial through hole 531 and its corresponding second radial through hole 541 remain properly aligned circumferentially.

Referring to FIGS. 7 and 8, in one embodiment of the present disclosure, as a preferred design, both the first radial through holes 531 on the ball seat 53 and the second radial through holes 541 on the ball sleeve 54 are arranged in sets of three. The ball clamping mechanism 5 has three first clamping balls 55 and three second clamping balls 56, forming three pairs. Each pair is placed in one first radial through hole 531 and one second radial through hole 541, allowing for more effective movement of the clamping seat 52 and the heavy hammer body 3.

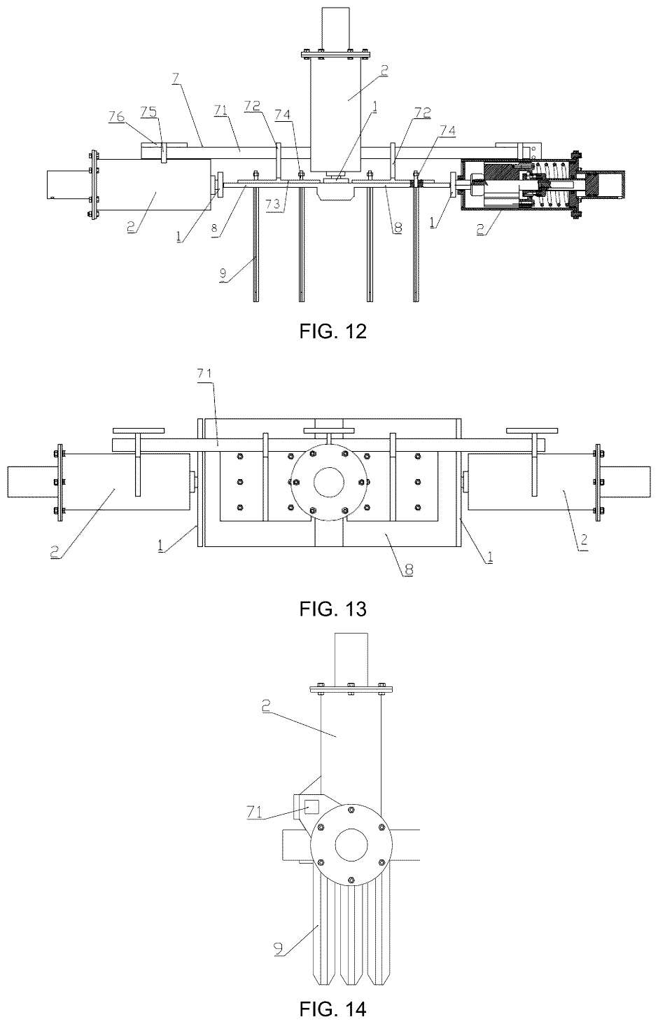

Referring to FIGS. 11-14, the present disclosure further provides a seismic wave excitation device. The seismic wave excitation device is configured to generate seismic waves on a seabed. The seismic wave excitation device comprises a bracket 7, a chopping board 8, trigger rods 9, and vibration hammers, each of which is a vibration hammer as described in any one of the above embodiments of the present disclosure. The bracket 7 is fixedly mounted on the weight base 10, the chopping board 8 is connected with the bracket 7 and is configured to move in a horizontal direction and a vertical direction relative to the seabed, the chopping board 8 is mounted on a surface of the seabed, the trigger rods 9 are mounted on the chopping board 8 and are configured to be inserted into the seabed, and the vibration hammers are mounted on the bracket 7. One of the vibration hammers is located over the chopping board 8 and is configured to apply a vertical striking to the chopping board 8, and the other vibration hammers are located at sides of the chopping board 8 and each is configured to apply a horizontal striking to the chopping board 8, respectively.

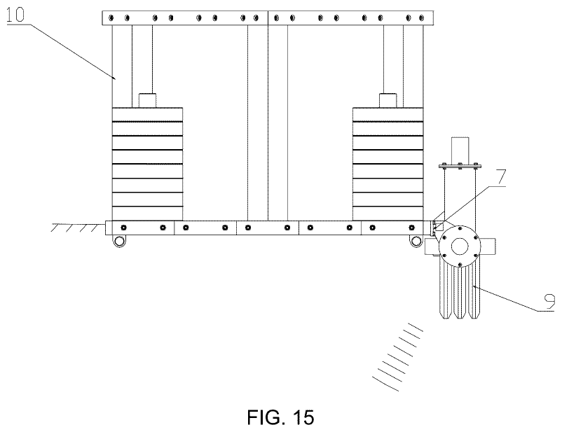

For the seismic wave excitation device of the present disclosure, when in use, the chopping board 8 is placed on the surface of the seabed and bears a downward pressure. Specifically, as shown in FIG. 15, the weight base 10 is placed on the surface of the seabed, and is heavy enough to sink to the seabed and firmly press against the seabed to maintain stability. The seismic wave excitation device is mounted on the weight base 10 through the bracket 7, ensuring that the chopping board 8 is pressed against the surface of the seabed, with the trigger rods 9 inserted into the seabed.

Referring to FIGS. 11, 12 and 13, the bracket 7 comprises a guide column 71, sliding rib plates 72, connecting plates 73, connecting guide rods 74, fixed rib plates 75, and flange plates 76. For the sake of clarity, the horizontal linear movement direction of the chopping board 8 is defined as the left-right direction, with the guide column 71 arranged accordingly. A vibration hammer is located at each side of the chopping board 8. Each of the vibration hammers is fixedly connected to one of the fixed rib plates 75, the fixed rib plate 75 is fixed on the guide column 71 and has a corresponding flange plate 76, and the flange plate 76 is connected to the weight base 10 by bolts. Each of the sliding rib plates 72 is mounted on the guide column 71 through a guide hole formed thereon, and is movable along the guide column 71. Each of the connecting plates 73 is fixed to one of the sliding rib plates 72. The chopping board 8 is located below the connecting plates 73, each of the connecting plates 73 is provided with guide holes to match with the connecting guide rods 74, each of the connecting guide rods 74 vertically extends through one of the guide holes, and a lower end of each of the connecting guide rods 74 is fixedly connected to the chopping board 8. The chopping board 8 moves vertically relative to the connecting plates 73 through gaps between the connecting guide rods 74 and the guide holes in the connecting plates 73. An upper end of each of the connecting guide rods 74 is threaded with a nut to limit the vertical movement of the chopping board 8 relative to the connecting plates 73, preventing the chopping board 8 from detaching from the connecting plates 73. When the chopping board 8 is struck on the left and right sides, it can move linearly along the guide column 71 through the connecting plates 73 and the sliding rib plates 72. When the chopping board 8 is struck on the upper surface, the chopping board 8 can move vertically through the connecting guide rods 74. In one embodiment of the present disclosure, the bracket 7 comprises two connecting plates 73, located on the left and right sides of the upper vibration hammer, and the connecting plates 73 are connected to the chopping board 8 by multiple connecting guide rods 74 to ensure the stability of the installation and the vertical movement of the chopping board 8. The guide column 71 has a square cross-section to prevent the chopping board 8 from swaying back and forth when moving left and right.

In one embodiment of the present disclosure, referring to FIGS. 11, 12, and 14, multiple trigger rods 9 are fixedly connected below the chopping board 8. The trigger rods 9 have appropriate lengths and are inserted into the seabed at an adequate depth. When the chopping board 8 is struck and sways left and right, the vibration is transmitted to the seabed through the trigger rods 9, causing the seabed to vibrate and generate shear waves. Preferably, each of the trigger rods 9 comprises a cylindrical pipe 91 and vertical strips 92 welded on two sides of the cylindrical pipe 91. The vertical strips 92 increase the trigger rods' contact area with the seabed, making the transmission of vibration to the seabed more effective.

In one embodiment of the present disclosure, the material and size of the chopping board 8, as well as the spacing and length of the trigger rods 9, are determined based on the hardness and compactness of the seabed to ensure effective vibration of the seabed under the action of the seismic wave excitation device. The chopping board 8 is rectangular and can be made of materials such as wood, steel, or nylon.

In one embodiment of the present disclosure, referring to FIGS. 11, 12, and 13, the striking direction of the vibration hammers on the left and right sides of the chopping board 8 is along the left-right direction, and the striking direction of the vibration hammer above the chopping board 8 is along the vertical direction. The distance between each striking head 1 and the chopping board 8 is appropriate. Since the structures of the vibration hammers on the left and right sides are identical, the kinetic energy of each strike is consistent, and the resulting waveforms have good repeatability. During shear wave measurement, the vibration hammers on the left and right sides alternately strike the chopping board 8 with the same time interval between each strike, producing two sets of shear waveforms with opposite phases. Since other waves may mix with the shear waves, the use of two sets of shear waveforms with opposite phases allows for better filtering with a wave velocity tester, ensuring that the calculations are based solely on shear waves and improving the accuracy of the test results. When compressional waves are needed, the vibration hammer above the chopping board 8 strikes the chopping board 8, causing it to vibrate vertically and compress the seabed, generating compressional waves.

In summary, the vibration hammer and the seismic wave excitation device of the present disclosure have the following beneficial effects.

1. The vibration hammer and the seismic wave excitation device of the present disclosure are suitable for automated underwater operations, eliminating the need for manual intervention underwater. They can operate fully automatically with control systems above water, making them particularly suitable for deep-sea operations.

2. The vibration hammer generates a consistent amount of kinetic energy with each use, ensuring stable and reliable performance. The seismic wave excitation device produces waveforms with excellent repeatability and has the capability of waveform superposition; it can generate two sets of shear waveforms with opposite phases, which, when received by detectors, can be better filtered through a wave velocity tester, thereby enhancing the accuracy of the test results.

The present disclosure effectively overcomes various shortcomings and has high industrial value.

The above-mentioned embodiments are for exemplarily describing the principle and effects of the present disclosure instead of limiting the present disclosure. Those skilled in the art can make modifications or changes to the above-mentioned embodiments without going against the spirit and the range of the present disclosure. Therefore, all equivalent modifications or changes made by those who have common knowledge in the art without departing from the spirit and technical concept disclosed by the present disclosure shall be still covered by the scope of the present disclosure.

1. A vibration hammer, comprising a housing (2), a striking head (1), a heavy hammer body (3), an elastic trigger structure (6), a ball clamping mechanism (5), and a telescopic power cylinder (4); wherein an accommodating inner cavity (21) within the housing (2) is sealed, the striking head (1) is mounted at a first end of the housing (2), with part of the striking head (1) located inside the accommodating inner cavity (21) and part of the striking head (1) located outside the housing (2), and the striking head (1) is configured to move linearly relative to the housing (2) in a striking direction; wherein the telescopic power cylinder (4) is fixed to a second end of the housing (2) opposite to the first end, and a piston rod (41) of the telescopic power cylinder (4) extends into the accommodating inner cavity (21) in the striking direction; wherein the elastic trigger structure (6) and the heavy hammer body (3) are mounted in the accommodating inner cavity (21), the heavy hammer body (3) is configured to move in the striking direction, and when the heavy hammer body (3) moves away from the striking head (1), the heavy hammer body (3) places the elastic trigger structure (6) in an elastic energy storage state, at which time the elastic trigger structure (6) applies an elastic force towards the striking head (1) to the heavy hammer body (3); wherein the ball clamping mechanism (5) comprises a positioning rod (51), a clamping seat (52), a ball seat (53), a ball sleeve (54), one or more first clamping balls (55), one or more second clamping balls (56), and a reset spring (57); wherein the positioning rod (51) is mounted in the accommodating inner cavity (21) and an axis of the positioning rod (51) is parallel to the striking direction, wherein the positioning rod (51) comprises a thick rod section (511) near the first end of the housing (2) and a thin rod section (512) near the second end of the housing (2), with a smooth transition surface between the thick rod section (511) and the thin rod section (512); wherein the ball seat (53) is sleeved on the positioning rod (51) and is fixedly connected to the piston rod (41), and the ball seat (53) is configured to move on the thick rod section (511); wherein the ball seat (53) is provided with one or more first radial through holes (531), each of the first clamping balls (55) is located in one of the first radial through holes (531), the ball seat (53) is further provided with a limiting stopper (532), the ball sleeve (54) is mounted on the ball seat (53), and the ball sleeve (54) is configured to move relative to the ball seat (53) along the striking direction and be locked circumferentially; wherein the ball sleeve (54) is provided with one or more second radial through holes (541), each of the second clamping balls (56) is located in one of the second radial through holes (541), the reset spring (57) applies an elastic force towards the first end of the housing (2) to the ball sleeve (54) to make the ball sleeve (54) abut the limiting stopper (532), and each of the second radial through holes (541) is aligned with a corresponding one of the first radial through holes (531); wherein the clamping seat (52) is fixedly connected to the heavy hammer body (3) and has a clamping portion (521), the clamping portion (521) has a clamping inner end (524) facing the positioning rod (51), and the ball seat (53) and the ball sleeve (54) pass between the clamping inner end (524) and the positioning rod (51) when moving; wherein the clamping inner end (524) has a first guide slope (522) facing the first end of the housing (2) and a second guide slope (523) facing the second end of the housing (2), distances from the clamping inner end (524) to the thick rod section (511) and the thin rod section (512) along a radial direction of the positioning rod (51) are denoted as H1 and H2, respectively, and diameters of each of the first clamping balls (55) and each of the second clamping balls (56) are denoted as D1 and D2, respectively, with H1<D1+D2≤H2.

2. The vibration hammer according to claim 1, wherein the striking head (1) comprises an outer striking plate (11) located outside the housing (2), an inner receiving head (12) located inside the accommodating inner cavity (21), and an intermediate rod (13) connecting the outer striking plate (11) and the inner receiving head (12), and the intermediate rod (13) extends through the housing (2) and is in sealing contact with the housing (2).

3. The vibration hammer according to claim 1, wherein an end of the positioning rod (51) facing the first end of the housing (2) is mounted in the striking head (1).

4. The vibration hammer according to claim 1, wherein the accommodating inner cavity (21) is cylindrical, an axis of the accommodating inner cavity (21) is in the striking direction, the heavy hammer body (3) is cylindrical and coaxially arranged in the accommodating inner cavity (21), the heavy hammer body (3) is in clearance fit with the accommodating inner cavity (21), and two parts of the accommodating inner cavity (21) located at two axial ends of the heavy hammer body (3) are in communication.

5. The vibration hammer according to claim 4, wherein the heavy hammer body (3) is provided with vent holes (31), and the vent holes (31) penetrate the heavy hammer body (3) in a direction parallel to the axis of the accommodating inner cavity (21).

6. The vibration hammer according to claim 1, wherein the elastic trigger structure (6) comprises a compression spring, the compression spring is located at a side of the heavy hammer body (3) near the second end of the housing (2), a first end of the compression spring is connected to the housing (2), and a second end of the compression spring contacts the heavy hammer body (3).

7. The vibration hammer according to claim 1, wherein the ball clamping mechanism (5) further comprises guide rods (58) fixed to the piston rod (41), the guide rods (58) are arranged in the striking direction, the ball sleeve (54) is provided with guide through holes, and each of the guide through holes is matingly connected to one of the guide rods (58).

8. A seismic wave excitation device, configured to generate seismic waves on a seabed, wherein the seismic wave excitation device comprises a bracket (7), a chopping board (8), trigger rods (9), and vibration hammers, each of which is a vibration hammer according to claim 1; wherein the chopping board (8) is connected with the bracket (7) and is configured to move in a horizontal direction and a vertical direction relative to the seabed, the chopping board (8) is mounted on a surface of the seabed, the trigger rods (9) are mounted on the chopping board (8) and are configured to be inserted into the seabed, and the vibration hammers are mounted on the bracket (7); wherein one of the vibration hammers is located over the chopping board (8) and is configured to apply a vertical striking to the chopping board (8), and the other vibration hammers are located at sides of the chopping board (8) and each is configured to apply a horizontal striking to the chopping board (8), respectively.

9. The seismic wave excitation device according to claim 8, wherein the bracket (7) comprises a guide column (71), sliding rib plates (72), connecting plates (73), and connecting guide rods (74); wherein the guide column (71) extends in the horizontal direction, each of the sliding rib plates (72) is mounted on the guide column (71) and movable along the guide column (71), and each of the connecting plates (73) is fixed to one of the sliding rib plates (72); wherein the chopping board (8) is located below the connecting plates (73), each of the connecting plates (73) is provided with guide holes to match with the connecting guide rods (74), each of the connecting guide rods (74) extends through one of the guide holes, and a lower end of each of the connecting guide rods (74) is fixedly connected to the chopping board (8).

10. The seismic wave excitation device according to claim 8, wherein each of the trigger rods (9) comprises a cylindrical pipe (91) and vertical strips (92) welded on two sides of the cylindrical pipe (91).
